(19) United States
(12) Patent Application Publication
(10) Pub. No.: US 2026/0158721 A1
(43) Pub. Date: Jun. 11, 2026

(54) MOLDING MANAGEMENT SYSTEM

(71) Applicant: SEIKO EPSON CORPORATION, Tokyo (JP)

(72) Inventors: Soji SHIOZAWA, MATSUMOTO-SHI (JP); Tomohiro TAKIZAWA, MATSUMOTO-SHI (JP)

(21) Appl. No.: 19/338,013

(22) Filed: Sep. 24, 2025

(30) Foreign Application Priority Data
Sep. 26, 2024 (JP) 2024-167459

(51) Int. Cl. B29C 45/76

(52) U.S. Cl. CPC B29C 45/76; B29C 2045/7606; B29C 2945/76939

(57) ABSTRACT

A molding management system for managing production of a product in a production process including an injection molding process of the product by an injection molding device, the molding management system includes an information processing device communicatively connected to a terminal device, wherein the information processing device includes a storage section configured to store data relating to injection molding and a control section, the data is associated with memo data indicating additional information, and the control section is configured to analyze the memo data associated with the data stored in the storage section in response to a received operation and to cause a display section to display analysis result information indicating a result of the analysis.

The present application is based on, and claims priority from JP Application Serial Number 2024-167459, filed Sep. 26, 2024, the disclosure of which is hereby incorporated by reference herein in its entirety.

### BACKGROUND

### 1. Technical Field

The present disclosure relates to a molding management system.

### 2. Related Art

Research and development have been conducted on a technique for managing production of a product in a production process including an injection molding process of the product by an injection molding device.

Here, a technique is known for displaying memo data indicating a memo used for information sharing between operators of injection molding device on the injection molding device (see JP-A-2004-168031).

However, the technique as described in JP-A-2004-168031 is merely a technique capable of recording, as memo data, injection molding conditions set in the injection molding device, a situation at the time of injection molding by the injection molding device, and the like. Therefore, in the technique as described in JP-A-2004-168031, it is not easy to specify the cause of the abnormality that has occurred in the cycle of injection molding by the injection molding device.

### SUMMARY

In order to solve the above problem, one aspect of the present disclosure is a molding management system for managing production of a product in a production process including an injection molding process of the product by an injection molding device, the molding management system includes an information processing device communicatively connected to a terminal device, wherein the information processing device includes a storage section configured to store data relating to injection molding and a control section, the data is associated with memo data indicating additional information, and the control section is configured to analyze the memo data associated with the data stored in the storage section in response to a received operation and to cause a display section to display analysis result information indicating a result of the analysis.

### BRIEF DESCRIPTION OF THE DRAWINGS

FIG. 1 is a diagram showing an example of a molding management system 1.

FIG. 2 is a diagram for explaining a method of specifying injection molding condition data to be associated with cycle data.

FIG. 3 is a diagram showing an example of a hardware configuration of an information processing device X.

FIG. 4 is a diagram showing an example of a functional configuration of the information processing device X.

FIG. 5 is a diagram showing an example of a flow of a process in which the information processing device X receives memo data to be associated with injection molding related data.

FIG. 6 is a diagram showing an example of a memo data reception image P1.

FIG. 7 is a diagram showing an example of an injection molding related data selection image P2.

FIG. 8 is a diagram showing an example of a flow of a process in which the information processing device X acquires target type injection molding related data.

FIG. 9 is a diagram showing an example of a timing specifying operation reception image P3.

FIG. 10 is a diagram showing an example of a list of cycle data stored in the information processing device X before the information processing device X receives a period start operation in a case where the target type is cycle data.

FIG. 11 is a diagram showing an example of the list of cycle data stored in the information processing device X after the information processing device X receives a period end operation in a case where the target type is cycle data.

FIG. 12 is a diagram showing another example of the list of cycle data stored in the information processing device X.

FIG. 13 is a diagram showing still another example of the list of the cycle data stored in the information processing device X.

FIG. 14 is a diagram showing an example of a search image P5.

FIG. 15 is a diagram showing an example of an image P6 received by the information processing device X with a time interval desired by a user as a target time interval.

FIG. 16 is a diagram showing target type injection molding related data grouped into two data groups according to the target time interval.

FIG. 17 is a diagram showing an example of an image P7 that receives an operation of selecting a desired data group from among a plurality of data groups.

FIG. 18 is a diagram showing an example of a flow of a process in which the information processing device X analyzes the memo data associated with the injection molding related data.

FIG. 19 is a diagram showing a plurality of pieces of second additional information as images indicating tags.

FIG. 20 is a diagram showing an example of a state in which the list of cycle data associated with a tag TG7 is displayed.

FIG. 21 is a diagram showing an example of a state in which the list of cycle data associated with each of two types of the second additional information is displayed.

### DESCRIPTION OF EMBODIMENTS

### Embodiment

Hereinafter, embodiments of the present disclosure will be described with reference to the drawings.

### Overview of Molding Management System

First, an overview of a molding management system according to the embodiment will be described.

The molding management system according to the embodiment manages production of a product in a production process including an injection molding process of the product by an injection molding device. The molding management system includes an information processing device. The information processing device is communicatively connected to a terminal device. The information processing device includes a storage section that stores data related to injection molding, and a control section. Here, memo data indicating additional information is associated with the data. The control section analyzes the memo data associated with the data stored in a storage section in response to a received operation and causes a display section to display analysis result information indicating the result of the analysis. By this, the molding management system can easily specify the cause of the abnormality that has occurred in the cycle of the injection molding by the injection molding device.

The molding management system according to the embodiment manages production of a product in a production process including the injection molding process of the product by the injection molding device. The molding management system includes an information processing device. The information processing device is communicatively connected to a terminal device. The information processing device includes a storage section that stores data related to injection molding, and a control section. Here, the memo data indicating the additional information is associated with the data. The control section sets a plurality of data satisfying a previously received condition as a data group according to the received operation, and displays an operation reception image for receiving an operation for associating the memo data indicating the additional information with all of the plurality of data included in the data group on the display section. By this, the molding management system can improve the efficiency of the work required for inputting the memo data.

Hereinafter, a configuration of the molding management system according to such an embodiment and a process performed by a server included in the molding management system will be described in detail.

### Configuration of Molding Management System

Hereinafter, a configuration of the molding management system according to the embodiment will be described by taking a molding management system 1 as an example.

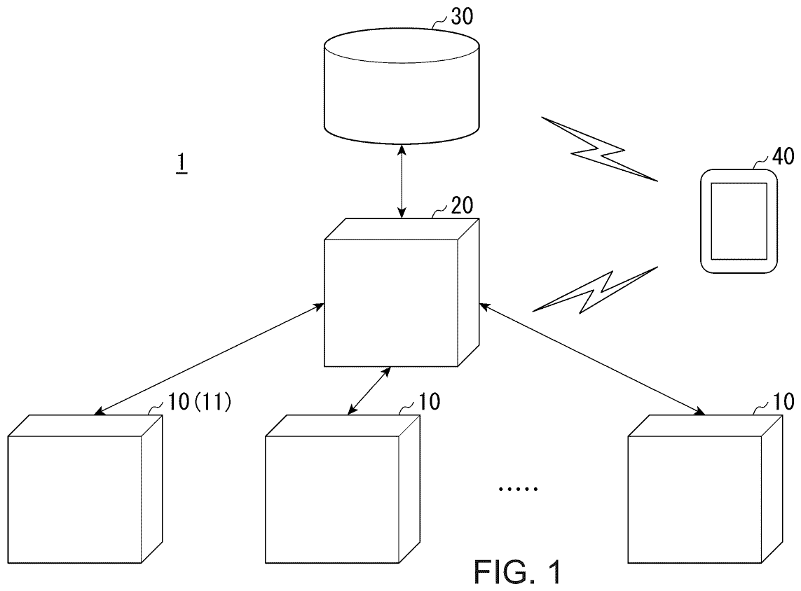

FIG. 1 is a diagram showing an example of the molding management system 1.

The molding management system 1 is a type of Manufacturing Execution System (MES). For example, the molding management system 1 includes one or more managed devices 10, an information processing device 20, and a server 30. Note that the molding management system 1 may be configured not to include a part or all of one or more managed devices 10. The molding management system 1 may be configured to include the server 30 without including the information processing device 20. The molding management system 1 may be configured to include the information processing device 20 and may not include the server 30. In the molding management system 1, the information processing device 20 may be configured integrally with the server 30. Hereinafter, as an example, a case will be described in which the molding management system 1 includes a plurality of managed devices 10 as the one or more managed devices 10. Hereinafter, as an example, a case will be described in which the molding management system 1 includes both the information processing device 20 and the server 30 separate from the information processing device 20. Note that at least one of the information processing device 20 and the server 30 is an example of an information processing device.

Each of the plurality of managed devices 10 included in the molding management system 1 is a device managed by the molding management system 1. In FIG. 1, the managed devices 10 are all indicated by the same reference symbols for convenience of description. However, some or all of the plurality of managed devices 10 may be different types of devices. The plurality of managed devices 10 includes at least one injection molding device that performs injection molding of a product using a resin such as plastic. An injection molding device 11 shown in FIG. 1 is an example of such an injection molding device. Note that the plurality of managed devices 10 may include an injection molding device that performs Metal Injection Molding (MIM) of a product. In the following description, for convenience of description, injection molding of the product using a resin such as plastic will be simply referred to as injection molding. In the following description, an injection molding device that performs injection molding of the product using a resin such as plastic will be simply referred to as an injection molding device. The plurality of managed devices 10 includes, in addition to the injection molding device, for example, a peripheral facility of the injection molding device. A peripheral facility of an injection molding device is, for example, a material supply device that supplies, to the injection molding device, a material used by the injection molding device for injection molding of the product, a transport device that transports the product injection molded by the injection molding device, a washing device that washes the product injection molded by the injection molding device, a sintering device that sinters the product after being washed by the washing device, and the like, but is not limited to these. At least one injection molding device included in the plurality of managed devices 10 may be a device that performs injection molding using a material other than resin and metal.

The molding management system 1 manages production of the product in the production process including the injection molding process of the product by the injection molding device included in the plurality of managed devices 10. Here, the injection molding device included in the plurality of managed devices 10 may have any configuration as long as the configuration enables the production of the product by injection molding. In the following description, for convenience of description, a process in which the injection molding device performs injection molding of the product once will be referred to as a cycle.

The information processing device 20 acquires various data, such as cycle data, injection molding condition data, and operational status history data from each of one or more injection molding devices included in the plurality of managed devices 10. Hereinafter, as an example, a case will be described in which three types of data, that is, the cycle data, the injection molding condition data, and the operational status history data, are acquired from each of the one or more injection molding devices by the information processing device 20. Note that the information processing device 20 independently acquires each of the three types of data. Therefore, in this example, the timings at which the three types of data are acquired by the information processing device 20 are different from each other except for a case where the timings match with each other by chance unless the timings are intentionally made to match with each other. In the following description, for convenience of description, these three types of data will be collectively referred to as injection molding related data unless it is necessary to distinguish them from each other. The injection molding related data is, in other words, data related to injection molding by the injection molding device.

For example, the information processing device 20 acquires the cycle data for each cycle. More specifically, the information processing device 20 acquires cycle data from each of the one or more injection molding devices every time each cycle ends. Here, the cycle data acquired from a certain injection molding device in a certain cycle is information including the one or more pieces of cycle related information obtained according to the execution of the cycle by the injection molding device, device identification information for identifying the injection molding device, and first date and time information indicating a date and time acquired by the information processing device 20 from the injection molding device. The cycle data may include other information in addition to the one or more pieces of cycle related information, the device identification information, and the first date and time information. The device identification information is, for example, an identifier (ID) for identifying the injection molding device, but may be other information capable of identifying the injection molding device, such as an internet protocol (IP) address assigned to the injection molding device. The device identification information may be included in the one or more pieces of cycle related information. Hereinafter, as an example, a case will be described in which the device identification information is included in the one or more pieces of cycle related information. In this case, the one or more pieces of cycle related information include, for example, some or all of detection information, operational status information, production quantity information, quality information, and the like, in addition to the device identification information. However, the information included in the one or more pieces of cycle related information is not limited to these. The detection information included in the cycle data as the cycle related information is information detected by each of one or more various sensors attached to the injection molding device, and is, for example, a part or all of information indicating a temperature, information indicating a pressure, information indicating a current value, information indicating a voltage value, and the like. The operational status information included in the cycle data as the cycle related information is information indicating an operational status of the injection molding device. The production quantity information included in the cycle data as the cycle related information is information indicating the number of products injection molded in the cycle. The quality information included in the cycle data as the cycle related information is information indicating the quality of the product injection molded in the cycle. The first date and time information indicating the date and time acquired by the information processing device 20 from the injection molding device may be a time stamp or other information indicating the date and time. Each cycle data including such information can be distinguished by a combination of the device identification information and the first date and time information. When only one injection molding device is connected to the information processing device 20, the cycle data may not include the device identification information. This is because, in this case, the cycle data can be distinguished only by the first date and time information. When acquiring certain cycle data, the information processing device 20 stores the acquired cycle data and outputs the acquired cycle data to the server 30. By this, the information processing device 20 can store the acquired cycle data in the server 30.

For example, the information processing device 20 acquires the injection molding condition data from each of one or more injection molding devices included in the plurality of managed devices 10 each time the injection molding condition is set in the injection molding device. Here, the injection molding condition data acquired from a certain injection molding device is information in which one or more pieces of injection molding condition information indicating the injection molding condition set in the injection molding device, the device identification information for identifying the injection molding device, and second date and time information indicating a date and time acquired by the information processing device 20 from the injection molding device are associated with each other. Note that the injection molding condition data may include other information in addition to the one or more pieces of injection molding condition information, the device identification information, and the second date and time information. The device identification information is, for example, an ID for identifying the injection molding device, but may be other information capable of identifying the injection molding device, such as an IP address assigned to the injection molding device. The device identification information may be included in the one or more pieces of injection molding condition information. Hereinafter, as an example, a case will be described in which the device identification information is included in the one or more pieces of injection molding condition information. In this case, the one or more pieces of injection molding condition information include, for example, some or all of information indicating an injection speed, information indicating the number of revolutions of a screw, information indicating a lower limit value of injection dwell pressure, information indicating an upper limit value of injection dwell pressure, and the like, in addition to the device identification information. However, the information included in the one or more pieces of injection molding condition information is not limited to these. The second date and time information indicating the date and time acquired by the information processing device 20 from the injection molding device may be a time stamp or other information indicating the date and time. When the information processing device 20 acquires certain injection molding condition data, the information processing device 20 stores the acquired injection molding condition data and outputs the acquired injection molding condition data to the server 30. By this, the information processing device 20 can store the acquired injection molding condition data in the server 30.

For example, the information processing device 20 acquires the operational status history data from each of one or more injection molding devices included in the plurality of managed devices 10 every time the power of the injection molding device is turned off. Here, the operational status history data acquired from a certain injection molding device is information in which operation start date and time information indicating a date and time when the power supply of the injection molding device is turned on, operation end date and time information indicating a date and time when the power supply of the injection molding device is turned off, the device identification information for identifying the injection molding device, and third date and time information indicating a date and time when the information processing device 20 acquires the operational status history data from the injection molding device are associated with each other. The operational status history data may include other information in addition to the operation start date and time information, the operation end date and time information, the device identification information, and the third date and time information. The device identification information is, for example, an ID for identifying the injection molding device, but may be other information capable of identifying the injection molding device, such as an IP address assigned to the injection molding device. The third date and time information indicating the date and time acquired by the information processing device 20 from the injection molding device may be a time stamp or other information indicating the date and time. The operational status history data may be a configuration included in the cycle data as the cycle related information. In this case, the operation information may be the operational status history data itself. When the information processing device 20 acquires certain operational status history data, the information processing device 20 stores the acquired operational status history data and outputs the acquired operational status history data to the server 30. By this, the information processing device 20 can store the acquired operational status history data in the server 30.

The information processing device 20 displays various images based on the injection molding related data stored in the information processing device 20 on a display section of a terminal device in response to a request from the terminal device communicably connected to the information processing device 20. Here, the image is a Graphical User Interface (GUI), an icon, a window on an Operating System (OS), or the like. Hereinafter, as an example, a case will be described in which the information processing device 20 is communicably connected to a terminal device 40 as shown in FIG. 1. Note that in the present embodiment, the process related to logging into the information processing device 20 by the terminal device 40 is a known process, and thus the description thereof will be omitted. In the following description, for convenience of description, the information processing device 20 receives an operation from the terminal device 40 via an image displayed on the terminal device 40 will be described as simply “the information processing device 20 receives an operation”. That is, in the following description, the information processing device 20 performs a certain process in accordance with the received operation means that the information processing device 20 performs a process in accordance with the operation received from the terminal device 40 via the image displayed on the terminal device 40.

The information processing device 20 is, for example, a workstation, a desktop Personal Computer (PC), a notebook PC, or the like, but is not limited to these. The information processing device 20 is communicably connected to each of the plurality of managed devices 10 by wired or wireless communication. A communication network connecting the information processing device 20 and each of the plurality of managed devices 10 is, for example, a Local Area Network (LAN) in a facility in which the plurality of managed devices 10 are installed, but is not limited to this. The communication network may be another communication network, such as the Internet or a mobile communication network.

The server 30 stores the cycle data acquired by the information processing device 20. For example, when the server 30 acquires certain cycle data from the information processing device 20, it stores the acquired cycle data.

The server 30 stores the injection molding condition data acquired by the information processing device 20. For example, when the server 30 acquires certain injection molding condition data from the information processing device 20, it stores the acquired injection molding condition data.

The server 30 stores the operational status history data acquired by the information processing device 20. For example, when the server 30 acquires certain operational status history data from the information processing device 20, it stores the acquired operational status history data.

The server 30 displays various images based on the injection molding related data stored in the server 30 on the display section of the terminal device in response to the request from the terminal device communicably connected to the server 30. Here, the image is the GUI, the icon, the window on the OS, or the like. Hereinafter, as an example, as shown in FIG. 1, a case will be described in which the server 30 is communicably connected to the terminal device 40. Note that in the present embodiment, a process related to logging into the server 30 by the terminal device 40 is a known process, and thus the description thereof will be omitted. In the following description, for convenience of description, the server 30 receiving an operation from the terminal device 40 via an image displayed on the terminal device 40 will be described as simply “the server 30 receives an operation”. That is, in the following description, the server 30 performs a certain process in accordance with the received operation means that the server 30 performs the process in accordance with the operation received from the terminal device 40 via the image displayed on the terminal device 40.

As described above, in the molding management system 1, both the information processing device 20 and the server 30 cause the display section of the terminal device 40 to display various images based on the stored injection molding related data in accordance with the received operation. Therefore, in the following description, for convenience of description, the information processing device 20 and the server 30 are collectively referred to as an information processing device X unless it is necessary to distinguish them. Note that the display section is, for example, a display of the terminal device 40, a display device communicably connected to the terminal device 40, or the like, but is not limited to these. Hereinafter, as an example, a case will be described in which the display section is a display of the terminal device 40. In the following description, for convenience of description, displaying a certain image on the display section will be referred to as displaying the image.

The information processing device X extracts the injection molding condition data corresponding to the cycle data from one or more pieces of molding condition data stored in advance for each of one or more pieces of cycle data, and associates the extracted injection molding condition data with the cycle data. At this time, the information processing device X associates one piece of cycle data with one piece of injection molding condition data. That is, the information processing device X associates the cycle data with the injection molding condition data in a one-to-one or many-to-one manner. Therefore, in the information processing device X, one piece of injection molding condition data is associated with each cycle data.

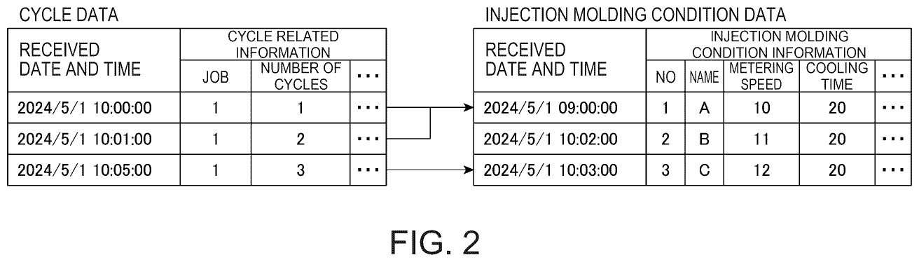

Here, a method of specifying the injection molding condition data associated with each cycle data will be described. When the information processing device X specifies the injection molding condition data to be associated with certain cycle data, the information processing device X extracts the one or more pieces of injection molding condition data including the device identification information included in the cycle data from the one or more pieces of injection molding condition data stored in advance. Also, the information processing device X specifies, as the injection molding condition data to be associated with the cycle data, the injection molding condition data including the second date and time information indicating the past date and time closest to the date and time indicated by the first date and time information included in the cycle data from among the extracted one or more pieces of injection molding condition data. FIG. 2 is a diagram for explaining a method of specifying injection molding condition data to be associated with cycle data. FIG. 2 shows three pieces of cycle data output from a certain injection molding device and three pieces of injection molding condition data output from the injection molding device. Specifically, FIG. 2 shows three pieces of cycle data, that is, the cycle data including first date and time information indicating 10:00:00 on May 1, 2024, the cycle data including first date and time information indicating 10:01:00 on May 1, 2024, and the cycle data including first date and time information indicating 10:05:00 on May 1, 2024. On the other hand, FIG. 2 shows three pieces of injection molding condition data, that is, the injection molding condition data including second date and time information indicating 9:00:00 on May 1, 2024 the injection molding condition data including second date and time information indicating 10:02:00 on May 1, 2024 and the injection molding condition data including second date and time information indicating 10:03:00 on May 1, 2024. For example, when the three pieces of cycle data shown in FIG. 2 are extracted by the information processing device X and the three pieces of injection molding condition data shown in FIG. 2 are stored in advance in the information processing device X, the information processing device X specifies the injection molding condition data to be associated with each of these three pieces of cycle data from among these three pieces of injection molding condition data. Specifically, the information processing device X specifies the injection molding condition data including the second date and time information indicating 09:00:00 on May 1, 2024 as the injection molding condition data associated with the cycle data including the first date and time information indicating 10:00:00 on May 1, 2024. This is because the past date and time closest to 10:00:00 on May 1, 2024 among the three dates and times of 09:00:00 on May 1, 2024, 10:02:00 on May 1, 2024, and 10:03:00 on May 1, 2024 is 09:00:00 on May 1, 2024. Similarly, the information processing device X specifies the injection molding condition data including the second date and time information indicating 09:00:00 on May 1, 2024 as the injection molding condition data associated with the cycle data including the first date and time information indicating 10:01:00 on May 1, 2024. Then, the information processing device X specifies the injection molding condition data including the second date and time information indicating 10:03:00 on May 1, 2024 as the injection molding condition data associated with the cycle data including the first date and time information indicating 10:05:00 on May 1, 2024. Therefore, in this case, the information processing device X does not specify the injection molding condition data including the second date and time information indicating 10:02:00 on May 1, 2024 as the injection molding condition data associated with any of the three pieces of cycle data shown in FIG. 2. By this, the information processing device X can omit unnecessary injection molding condition data and associate injection molding condition data necessary for a user with the cycle data. This makes it possible for the user to easily grasp the situation when an abnormality occurs in the product injection molded by the injection molding device, for example, and as a result, it is possible to easily specify the cause of the abnormality in the product. By the above described specifying method, the information processing device X can associate one piece of molding condition data with each of the three pieces of cycle data shown in FIG. 2. As a result, one piece of injection molding condition data is associated with each cycle data. In FIG. 2, the injection molding condition data associated with each cycle data is connected by an arrow. That is, in the example shown in FIG. 2, the information processing device X can associate one piece of injection molding condition data with one piece of cycle data. However, this also means that there may be a plurality of cycle data associated with a certain injection molding condition data. However, for example, when an abnormality occurs in the quality of the product molded by injection molding, the user often identifies the cause of the abnormality while viewing the cycle data. Therefore, even if the cycle data and the injection molding condition data are associated with each other in a many-to-one manner, when the number of pieces of injection molding condition data associated with each cycle data is one, the information processing device X can prevent the work required for specifying the cause of the abnormality from becoming complicated. Therefore, the information processing device X does not associate a plurality of injection molding condition data with one piece of cycle data, but associates one piece of injection molding condition data with one piece of cycle data. For example, the injection molding conditions set in the injection molding device are not usually changed during the execution of the cycle. Therefore, even if the injection molding conditions are set in the injection molding device a plurality of times before the execution of the cycle, the injection molding conditions actually set in the injection molding device at the time of the execution of the cycle are the injection molding conditions set in the injection molding device last until the execution of the cycle is started. Under such circumstances, when the injection molding device outputs certain cycle data, the injection molding condition set in the injection molding device at the time of output of the cycle data is nothing but the injection molding condition indicated by the injection molding condition data including the second date and time information indicating the past date and time closest to the date and time indicated by the first date and time information included in the cycle data. Therefore, the information processing device X associates the cycle data with the injection molding condition data by the method described above. Note that the injection molding conditions are set in the injection molding device a plurality of times before the execution of the cycle may occur when erroneous injection molding conditions are set in the injection molding device, when the injection molding conditions are changed for some reason, or when trial and error is executed for obtaining better injection molding conditions. Such association between the cycle data and the injection molding condition data may be performed in the information processing device X every time the cycle data is stored in the information processing device X. Such association between the cycle data and the injection molding condition data may be performed in the information processing device X at another timing, such as a timing at which a predetermined operation is received from the user.

The information processing device X groups the one or more pieces of injection molding related data satisfying extraction condition received in advance as a data group in accordance with the received operation, and associates the memo data indicating the additional information with all of the plurality of pieces of injection molding related data included in the grouped data group. Here, in the present embodiment, even if the number of pieces of injection molding related data satisfying the extraction condition is one, the one piece of injection molding related data is referred to as the data group and described. Since the memo data can be associated with the injection molding related data in this manner, the user of the information processing device X can easily grasp various kinds of information that cannot be recognized only by the injection molding related data, by the memo data. The information processing device X associates the memo data indicating additional information with all of the plurality of injection molding related data included in the data group, and thus, it is possible to improve the efficiency of the work required for inputting the memo data. Note that the number of types of injection molding related data included in the data group may be two or more. That is, for example, the information processing device X may be configured to group the one or more pieces of cycle data and the one or more pieces of injection molding condition data as the data group. However, hereinafter, for simplification of description, a case will be described in which the number of types of injection molding related data included in the data group is one.

Here, the additional information indicated by the memo data may be any information. Therefore, for example, the memo data includes at least one of text data, image data, speech data, and read data read from encoded data indicating encoded information. Note that the memo data may include other data instead of some or all of the above or in addition to all of the above. For example, the additional information indicated by the memo data is information indicating the status of the injection molding condition executed in the cycle, but is not limited to this.

The information processing device X analyzes the memo data associated with the stored injection molding related data in response with the received operation, and displays analysis result information indicating the result of the analysis. By this, the information processing device X can easily specify the cause of the abnormality that has occurred in the cycle of the injection molding by the injection molding device. Note that such analysis of the memo data may be performed by a known method using, for example, natural language analysis, Artificial Intelligence (AI), an algorithm of machine learning, statistical analysis, or the like, or may be performed by a method to be developed in the future.

### Hardware Configuration of Information Processing Device X

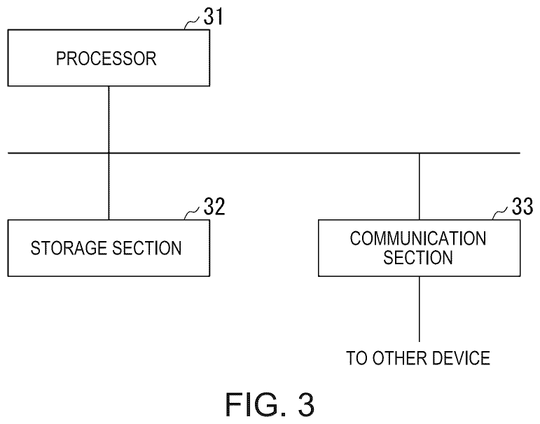

Here, the information processing device 20 and the server 30 may have the same hardware configuration or different hardware configurations. Hereinafter, as an example, a case will be described in which the information processing device 20 and the server 30 have the same hardware configuration. In other words, in this example, the information processing device X has a hardware configuration as shown in FIG. 3. FIG. 3 is a diagram showing an example of a hardware configuration of the information processing device X.

The information processing device X includes, for example, a processor 31, a storage section 32, and a communication section 33. These components are communicatively connected to each other via a bus. The information processing device X communicates with other devices via the communication section 33. The other device is, for example, in a case where the information processing device X is the information processing device 20, the injection molding device, the server 30, the terminal device 40, or the like. The other device is, for example, the terminal device 40, or the like in a case where the information processing device X is the server 30, the information processing device 20.

The processor 31 is, for example, a Central Processing Unit (CPU). Note that the processor 31 may be another processor, such as a Field Programmable Gate Array (FPGA), instead of the CPU. The processor 31 executes various programs stored in the storage section 32.

The storage section 32 is a storage device including, for example, a Hard Disk Drive (HDD), a Solid State Drive (SSD), an Electrically Erasable Programmable Read Only Memory (EEPROM), a Read Only Memory (ROM), a Random Access Memory (RAM), and the like. Note that the storage section 32 may be an external storage device connected by a digital input and output port, such as a Universal Serial Bus (USB), instead of being built in the information processing device X. The storage section 32 stores various types of information, various images, and various programs processed by the information processing device X. That is, various information stored in the information processing device X are stored in the storage section 32.

The communication section 33 is a communication device that includes, for example, a digital input and output port, such as a USB, an Ethernet (registered trademark) port, an antenna for wireless communication, and the like.

### Functional Configuration of Information Processing Device X

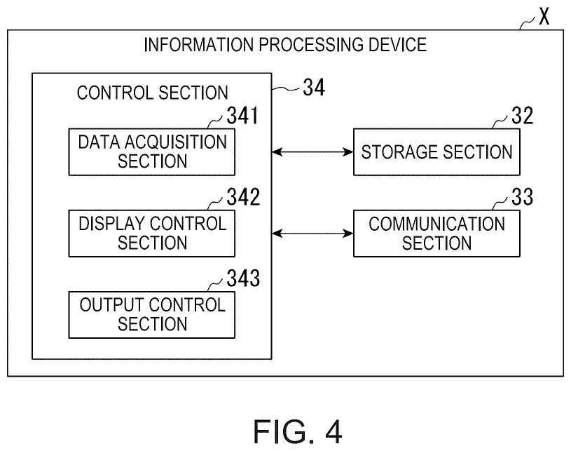

Here, the information processing device 20 and the server 30 may have the same functional configuration or different functional configurations. Hereinafter, as an example, a case will be described in which the information processing device 20 and the server 30 have the same functional configuration. In other words, in this example, the information processing device X has the functional configuration as shown in FIG. 4. FIG. 4 is a diagram showing an example of the functional configuration of the information processing device X.

The information processing device X includes the storage section 32, the communication section 33, and a control section 34.

The control section 34 controls the information processing device X as a whole. The control section 34 includes at least a data acquisition section 341, a display control section 342, and an output control section 343. These functional sections of the control section 34 are realized, for example, by the processor 31 executing various programs stored in the storage section 32. Some or all of the functional sections may be hardware functional sections, such as a Large Scale Integration (LSI) and an Application Specific Integrated Circuit (ASIC).

The data acquisition section 341 acquires the injection molding related data of each injection molding device from a device communicably connected to the information processing device X. The device is, for example, the injection molding device, the information processing device 20, or the like.

The display control section 342 generates various images in accordance with the received operation. The display control section 342 transmits the generated image to the terminal device 40 and causes the terminal device 40 to display the image.

The output control section 343 outputs various data to another device in accordance with the received operation. For example, the output control section 343 outputs the injection molding related data to another device.

### Process of Receiving Memo Data Associated with Injection Molding Related Data by Information Processing Device X

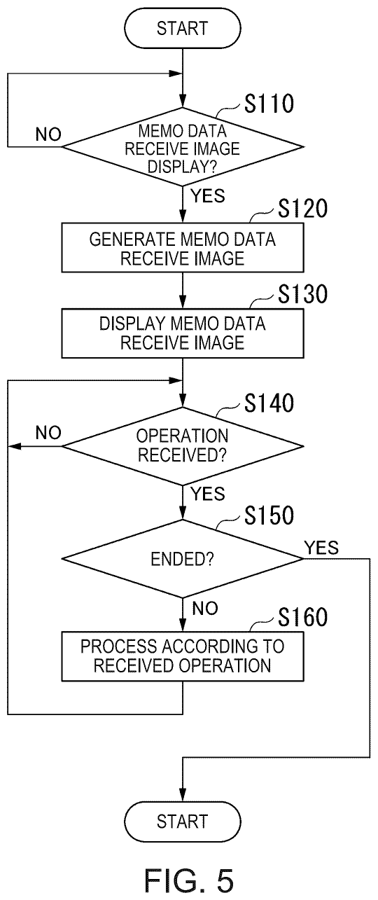

A process in which the information processing device X receives the memo data to be associated with the injection molding related data will be described with reference to FIG. 5. FIG. 5 is a diagram showing an example of a flow of a process in which the information processing device X receives memo data to be associated with the injection molding related data. Hereinafter, as an example, a case will be described in which, at a timing before the processing of step S110 shown in FIG. 5 is performed, a plurality of each of all types of injection molding related data are already stored in the information processing device X. In the following description, for convenience of description, the memo data associated with the injection molding related data will be referred to as target memo data.

The control section 34 waits until an operation of displaying a memo data reception image P1 for receiving the target memo data is received (step S110). In FIG. 5, the process of step S110 is indicated by “MEMO DATA RECEIVE IMAGE DISPLAY?”. Here, the memo data reception image P1 will be described.

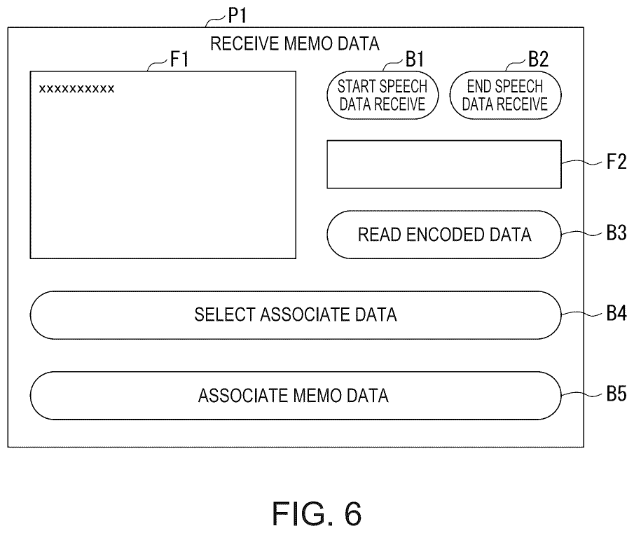

FIG. 6 is a diagram showing an example of the memo data reception image P1. The memo data reception image P1 includes, for example, two input fields of an input field F1 and an input field F2, and five buttons of a button B1 to a button B5. Note that the memo data reception image P1 may include another Graphical User Interface (GUI) instead of or all of the above or in addition to all of the above. Note that the memo data reception image P1 is an example of an operation reception image.

The input field F1 is a field in which is input a character string. When the character string is input in the input field F1, the information processing device X receives the input character string as text to be included in the target memo data. In the example shown in FIG. 6, a text string “xxxxxxxxxx” is input in the input field F1, for example. The input field F1 is an example of a text reception image.

The input field F2 is a field in which is input an image data. For example, when the image data is input to the input field F2, the information processing device X receives the input image data as an image data to be included in the target memo data. In the example shown in FIG. 6, nothing is input in the input field F2. The method of inputting the image data to the input field F2 may be a drag-and-drop method or other methods. Note that the memo data reception image P1 may not include the input field F2 when the image data is not included in the memo data. The information processing device X may be configured to receive by the information processing device X data obtained by converting the received image data into text data by image recognition such as an Optical Character Recognition/Reader (OCR) as text data to be included in the target memo data. In this case, the memo data reception image P1 may not include the input field F1. The input field F2 is an example of an image reception image. The information processing device X may include an imaging section such as a camera for acquiring image data. In this case, the image data captured by the information processing device X may be input to the input field F2.

The button B1 is a button for the information processing device X to receive a speech recording start operation for starting speech recording. Note that, in a case where the information processing device X records a speech, the information processing device X includes a sound collection device such as a microphone. However, in a case where the information processing device X includes the sound collection device, the information processing device X may be configured to include an external sound collection device or may be configured to include a built-in sound collection device. When the information processing device X receives a selection operation at the button B1, the information processing device X starts recording of the speech collected by the sound collection device included in the information processing device X. That is, in this case, the information processing device X starts storing the speech data indicating the speech. The recording of the speech started in this manner is continued until the information processing device X receives a selection operation at the button B2. Note that in the present embodiment, the selection operation is a click, a tap, or the like, but is not limited to these. The button B1 is an example of a speech recording start image. The selection operation at the button B1 is an example of the speech recording start operation.

The button B2 is a button for the information processing device X to receive a speech recording end operation for ending the speech recording. When the information processing device X receives the selection operation at the button B1 and then receives the selection operation at the button B2, the information processing device X ends the recording of the speech collected by the sound collection device included in the information processing device X. That is, in this case, the information processing device X ends storing the speech data indicating the speech. Then, the information processing device X receives the stored speech data as speech data to be included in the target memo data. Note that when the information processing device X receives the selection operation at the button B1 before receiving the selection operation at the button B2, the information processing device X does nothing, for example. The information processing device X may be configured to receive data obtained by converting stored speech data into text data by speech recognition or the like as text data to be included in the target memo data. In this case, the information processing device X may be configured not to receive the stored speech data as the speech data to be included in the target memo data. The button B2 is an example of a speech recording end image. The selection operation at the button B2 is an example of a speech recording end operation.

Note that the memo data reception image P1 may be configured not to include the button B1 and the button B2 when the memo data does not include speech data. The memo data reception image P1 may not include the input field F1 when the information processing device X receives the text data obtained by converting the stored speech data through speech recognition or the like as the text data to be included in the target memo data.

The button B3 is a button for receiving an operation to cause an encoded data reading device, which reads read data from the encoded data, to start reading the read data. Here, the encoded data is data encoded into a one dimensional or two dimensional code such as a barcode, a QR code (registered trademark), or a color code. The encoded data reading device is a device that reads data encoded as a one dimensional or two dimensional code from the code, such as a barcode reader, a QR code reader, or a color code reader. In the case of receiving the operation, the information processing device X includes the encoded data reading device. However, when the information processing device X includes the encoded data reading device, the information processing device X may include an external encoded data reading device or may include a built-in encoded data reading device. When the information processing device X receives a selection operation at the button B3, the information processing device X makes the encoded data reading device included in the information processing device X start reading the read data from the code in which the read data is encoded. By this, the information processing device X receives the read data read by the encoded data reading device as the read data to be included in the target memo data. Note that the memo data reception image P1 may not include the button B3 when the memo data does not include the read data. The memo data reception image P1 may be configured such that the information processing device X receives data obtained by converting the received read data into text data as the text data to be included in the target memo data. In this case, the memo data reception image P1 may not include the input field F1. The button B3 is an example of a read operation reception image.

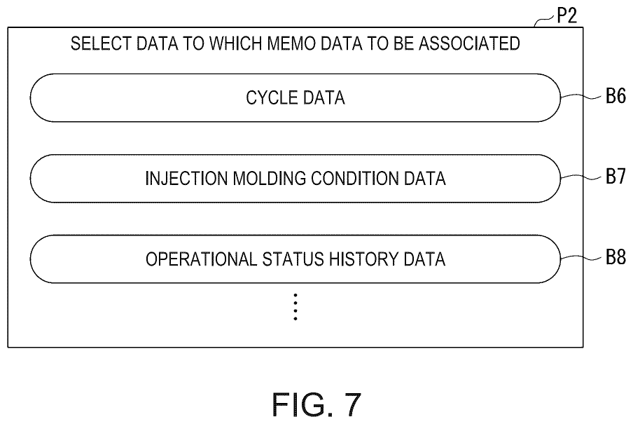

The button B4 is a button for receiving an operation of selecting the type of the injection molding related data to be associated with the target memo data including the data received by the information processing device X by at least one of the input field F1, the input field F2, the button B1, the button B2, and the button B3. When the information processing device X receives a selection operation at the button B4, the information processing device X displays, for example, an injection molding related data selection image P2 as Shown in FIG. 7. In the following description, for convenience of description, the type selected as the type of the injection molding related data with which the target memo data is associated will be referred to as a target type.

FIG. 7 is a diagram showing an example of the injection molding related data selection image P2. The injection molding related data selection image P2 includes, for example, three buttons of a button B6 to a button B8. Note that the injection molding related data selection image P2 may include another GUI instead of some or all of the three buttons or in addition to all of the three buttons.

The button B6 is a button for receiving an operation of selecting the cycle date as the target type. When a selection operation is performed at the button B6, the information processing device X selects the cycle data as the target type. After selecting the cycle data as the target type, the information processing device X specifies the extraction condition for extracting desired cycle data from the cycle data in accordance with the received operation. Hereinafter, for convenience of description, the extraction condition will be referred to as a cycle data extraction condition. Here, a method in which the information processing device X specifies the cycle data extraction condition in accordance with the received operation may be a known method or a method to be developed in the future. After specifying the cycle data extraction condition, the information processing device X acquires cycle data satisfying the specified cycle data extraction condition and groups the acquired cycle data as the data group. The information processing device X may be configured to display the list of the cycle data acquired in this manner or may be configured not to display the list.

The button B7 is a button for receiving an operation of selecting the injection molding condition data as the target type. When a selection operation is performed at the button B7, the information processing device X selects the injection molding condition data as the target type. After selecting the injection molding condition data as the target type, the information processing device X specifies the extraction condition for extracting desired injection molding condition data from the injection molding condition data in accordance with the received operation. Hereinafter, for convenience of description, the extraction condition will be referred to as an injection molding condition data extraction condition. Here, a method in which the information processing device X specifies the injection molding condition data extraction condition in accordance with the received operation may be a known method or a method to be developed in the future. After specifying the injection molding condition data extraction condition, the information processing device X acquires the injection molding condition data satisfying the specified injection molding condition data extraction condition, and groups the acquired cycle data as the data group. The information processing device X may be configured to display a list of the injection molding condition data acquired in this manner, or may be configured not to display the list.

The button B8 is a button for receiving an operation of selecting the operational status history data as the target type. When a selection operation is performed at the button B8, the information processing device X selects the operational status history data as the target type. After selecting the operational status history data as the target type, the information processing device X specifies the extraction condition for extracting desired operational status history data from the operational status history data in accordance with the received operation. Hereinafter, for convenience of description, the extraction condition will be referred to as an operational status history data extraction condition. Here, a method in which the information processing device X specifies the operational status history data extraction condition in accordance with the received operation may be a known method or a method to be developed in the future. After specifying the operational status history data extraction condition, the information processing device X acquires the operational status history data satisfying the specified operational status history data extraction condition, and groups the acquired cycle data as the data group. The information processing device X may be configured to display a list of the operational status history data acquired in this manner, or may be configured not to display the list.

Hereinafter, for convenience of description, the injection molding related data of the target type will be referred to as target type injection molding related data. After acquiring the target type injection molding related data, the information processing device X deletes the display of the injection molding related data selection image P2, and waits until receiving the selection operation at the button B5 included in the memo data reception image P1, for example.

The button B5 is a button for receiving an operation of associating the acquired target type injection molding related data with the target memo data. When the information processing device X receives the selection operation at the button B5, the information processing device X associates the target memo data with all of the target type injection molding related data grouped as the data group. More specifically, when there is one piece of the target type injection molding related data, the information processing device X associates the target memo data with the one piece of the target type injection molding related data. On the other hand, when there are a plurality of pieces of the target type injection molding related data, the information processing device X associates the target memo data with the plurality of pieces of the target type injection molding related data. In this manner, the information processing device X groups one or more pieces of target type injection molding related data as the data group, and associates the target memo data with all the pieces of target type injection molding related data included in the grouped data group. By this, the information processing device X can improve the efficiency of the work required for inputting the target memo data.

### Process of Acquiring Target Injection Molding Related Data by Information Processing Device X

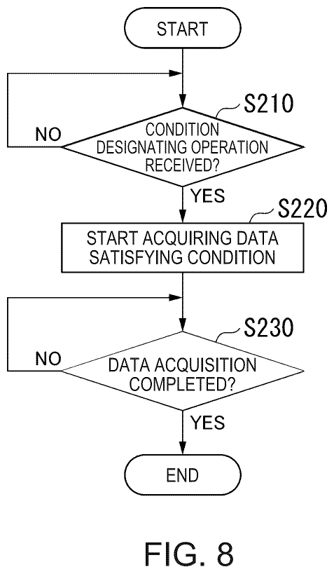

Hereinafter, a process in which the information processing device X acquires the target type injection molding related data will be described with reference to FIG. 8. FIG. 8 is a diagram showing an example of a flow of a process in which the information processing device X acquires target type injection molding related data. Hereinafter, as an example, a case will be described in which, at a timing before the process of step S210 shown in FIG. 8 is performed, the information processing device X selects the target type. Hereinafter, for convenience of description, the extraction condition according to the target type will be referred to as a target extraction condition. For example, when the target type is the cycle data, the target extraction condition is the cycle data extraction condition. For example, when the target type is the injection molding condition data, the target extraction condition is the injection molding condition data extraction condition. For example, when the target type is the operational status history data, the target extraction condition is the operational status history data extraction condition. Hereinafter, for convenience of description, the target type injection molding related data satisfying the target extraction condition will be referred to as target data.

After the information processing device X selects the target type, the control section 34 waits until an operation of designating the target extraction condition from among a plurality of predetermined conditions is received (step S210). Here, the operation may be any operation. In FIG. 8, the process of step S210 is indicated by “CONDITION DESIGNATING OPERATION RECEIVED?”. Note that, in the following description, each of the plurality of predetermined conditions is referred to as an extraction condition candidate.

When it is determined that the operation of designating the target extraction condition from among the plurality of extraction condition candidates is received (step S210: YES), the control section 34 starts acquisition of the target data based on the target extraction condition designated by the received operation (step S220). In FIG. 8, the process of step S220 is indicated by “START ACQUIRING DATA SATISFYING CONDITION”.

Next, the control section 34 waits until the acquisition of the target data started in step S220 is completed (step S230). Note that a method in which the control section 34 specifies whether or not the acquisition the target data has been completed may be a known method or a method to be developed in the future. In FIG. 8, the process of step S230 is indicated by “DATA ACQUISITION COMPLETED?”.

When the control section 34 determines that the acquisition of the target image started in step S220 is completed (step S230: YES), the control section 34 ends the process of the flowchart shown in FIG. 8 and waits until, for example, the selection operation at the button B5 described above is received.

As described above, the information processing device X acquires the target data. By this, the information processing device X can easily associate desired memo data with all the injection molding related data desired by the user. As a result, the information processing device X can improve the efficiency of the work required for inputting the memo data.

### Specific Example of Extraction Condition Candidate

Hereinafter, a specific example of the extraction condition candidate will be described.

One of the plurality of extraction condition candidates may be, for example, a first extraction condition candidate. The first extraction condition candidate is the target type injection molding related data acquired within a target acquisition period from an acquisition start operation is received to an acquisition end operation is received. The acquisition start operation is an operation for causing the information processing device X to specify a timing at which the target acquisition period is started. When the acquisition start operation is received, the information processing device X specifies the timing at which the acquisition start operation is received as a period start timing at which the target acquisition period is started. On the other hand, the acquisition end operation is an operation for causing the information processing device X to specify a timing at which the target acquisition period is ended. When the acquisition end operation is received, the information processing device X specifies the timing at which the acquisition end operation is received as a period end timing at which the target acquisition period is ended.

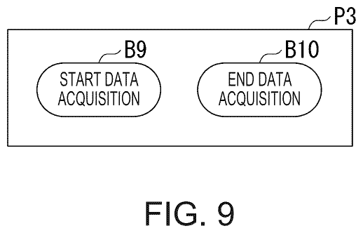

For example, the information processing device X receives each of the acquisition start operation and the acquisition end operation via a timing specifying operation reception image P3 shown in FIG. 9. FIG. 9 is a diagram showing an example of the timing specifying operation reception image P3. In the example shown in FIG. 9, the timing specifying operation reception image P3 includes, for example, two buttons, a button B9 and a button B10. Note that the timing specifying operation reception image P3 may include other GUI in addition to these two buttons.

The button B9 is a button for receiving the acquisition start operation. When the information processing device X receives a selection operation at the button B9, it specifies the period start timing.

The button B10 is a button for receiving the acquisition end operation. When the information processing device X receives a selection operation at the button B10, it specifies the period end timing. When the period start timing and the period end timing are specified, the information processing device X specifies, as the target data, the target type injection molding related data acquired by the information processing device 20 from the injection molding device within the target acquisition period from the specified period start timing to the specified period end timing. After specifying the target data, the information processing device X groups all the specified target data as the data group, and associates the target memo data with the grouped data group.

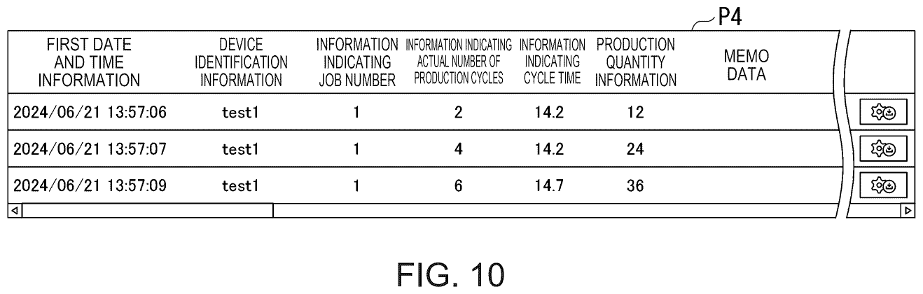

FIG. 10 is a diagram showing an example of the list of cycle data stored in the information processing device X before the information processing device X receives a period start operation in a case where the target type is the cycle data. An image P4 shown in FIG. 10 is an example of an image displaying the list of results of cycle data search by the information processing device X in response to the received operation. In the example shown in FIG. 10, the information processing device X displays the list of results of searching for all the cycle data stored in the storage section 32. In this example, three pieces of cycle data are stored in the information processing device X. Therefore, these three cycles are displayed in the image P4. More specifically, these three cycles are displayed in the image P4 in ascending date and time order. As shown in FIG. 10, the target memo data is not associated with these three cycle data.

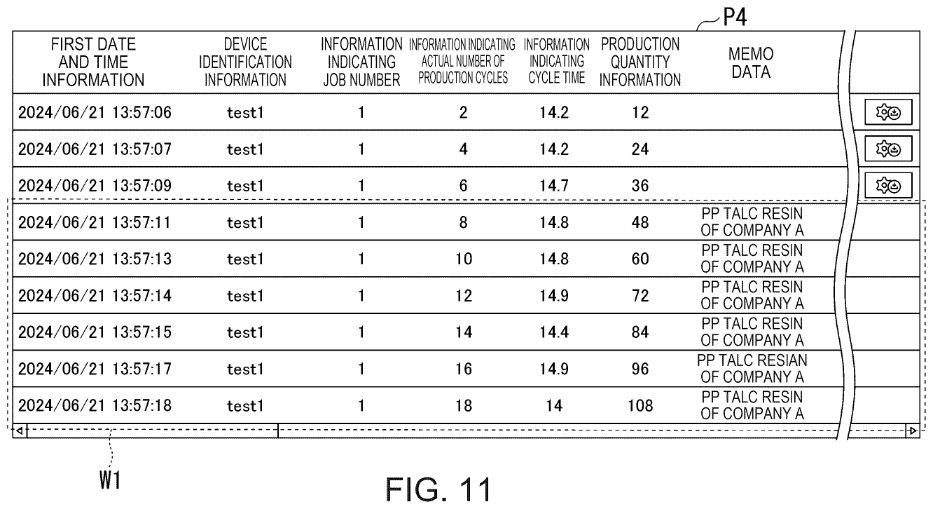

On the other hand, FIG. 11 is a diagram showing an example of the list of cycle data stored in the information processing device X after the information processing device X receives a period end operation in a case where the target type is the cycle data. In this case, six pieces of cycle data are displayed in the image P4 in addition to the three cycle data shown in FIG. 10. That is, the information processing device X can display the target memo data associated with the target data together with the target data in accordance with the received operation. A total of nine cycles are displayed in the image P4 in ascending date and time order. In this case, the cycle data, which is the target type injection molding related data acquired by the information processing device X as the target data, is these six pieces of cycle data. In FIG. 11, these six cycle data are surrounded by a frame W1. As shown in FIG. 11, the information processing device X associates the target memo data with the six pieces of cycle data. In the example shown in FIG. 11, the target memo data associated with these six pieces of cycle data is text data indicating a character string “PP TALC RESIN OF COMPANY A”. Here, in a case where the target type is the cycle data, after the information processing device X receives the period end operation, the information processing device X groups the target type injection molding related data acquired within the target acquisition period from the timing at which the period start operation is received to the timing at which the period end operation is received as the data group of the target data, and associates the target memo data with all of the grouped data groups. As a result, in the image P4 shown in FIG. 11, the group of six cycle data associated with the target memo data is displayed in the area surrounded by the frame W1. The image P4 is an example of a data group display image.

Here, a first extraction condition candidates described in FIG. 9 to FIG. 11 are conditions for extracting the target type injection molding related data before being acquired by the information processing device X as the target data. However, one of the plurality of extraction condition candidates may be, for example, a second extraction condition candidate. The second extraction condition candidate is a condition for extracting the target type injection molding related data acquired by the information processing device X as the target data. Specifically, the second extraction condition candidate is the target type injection molding related data associated with the injection molding condition data indicating a common injection molding condition. In this case, after specifying the target type injection molding related data, the information processing device X receives, as the common injection molding condition data, the injection molding condition data desired by the user as the injection molding condition data associated with the target data, for example, in accordance with the received operation. By this, the information processing device X can acquire the target type injection molding related data associated with the common injection molding condition data as the target data from the target type injection molding related data stored in the storage section 32.

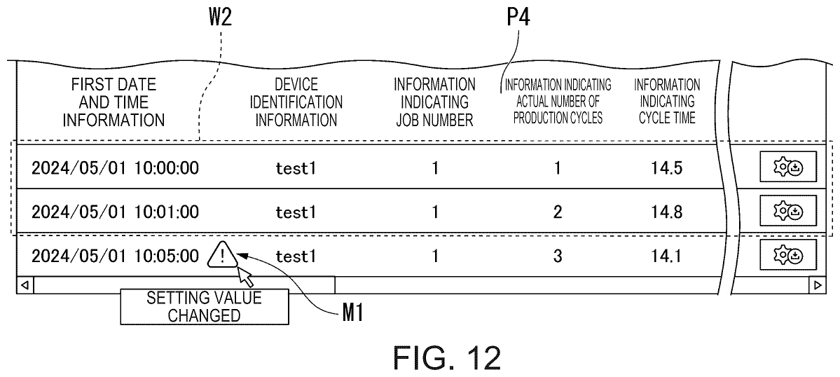

FIG. 12 is a diagram showing another example of the list of cycle data stored in the information processing device X. In the example shown in FIG. 12, three cycle data are displayed in the image P4 in ascending date and time order. In this example, when the injection molding condition data associated with the two cycle data arranged in ascending date and time order in the image P4 are different from each other, the information processing device X displays, in the image P4, the injection molding condition change information indicating that the injection molding condition has been changed, in association with the cycle data having the newer date and time indicated by the first date and time information included in the two cycle data. A mark M1 shown in FIG. 12 is an example of such injection molding condition change information. Therefore, in this example, among the three cycle data displayed in the image P4, the two cycle data, that is, the uppermost cycle data and the middle cycle data, are associated with injection molding condition data indicating the common injection molding conditions. In FIG. 12, these two cycle data are surrounded by a frame W2. Therefore, when the information processing device X receives the injection molding condition data as the common injection molding condition data, it can acquire the two pieces of cycle data as the target data from the cycle data stored in the storage section 32. After acquiring the target data, the information processing device X groups the acquired target data as the data group, and associates the target memo data with the grouped data group.

One of the plurality of extraction condition candidates may be, for example, a third extraction condition candidate. The third extraction condition candidate is also a condition for extracting the target type injection molding related data acquired by the information processing device X as the target data. Specifically, the third extraction condition candidate is the target type injection molding related data acquired by the information processing device 20 in a common operation period. Here, the operation period is a period from a timing at which the power supply of the injection molding device is turned on to a timing at which the power supply of the injection molding device is turned off. In this case, the information processing device X can specify the operation period for each injection molding device based on the operational status history data. Then, after specifying the target type injection molding related data, the information processing device X receives the operation period desired by the user as the target operation period, for example, in accordance with the received operation. By this, the information processing device X can acquire the target type injection molding related data acquired within the target operation period as the target data from the target type injection molding related data stored in the storage section 32.

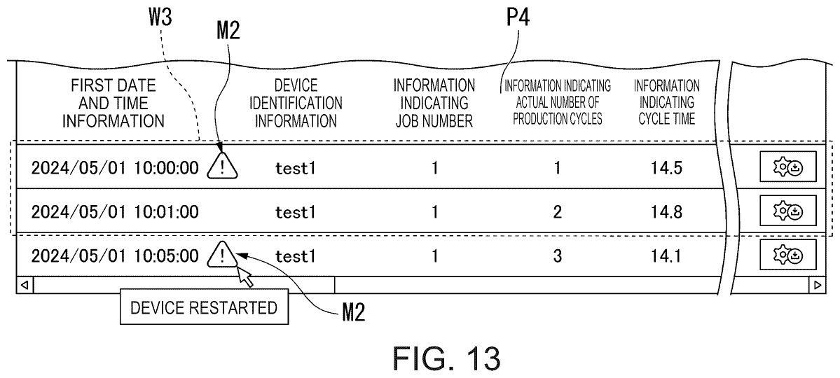

FIG. 13 is a diagram showing still another example of the list of the cycle data stored in the information processing device X. In the example shown in FIG. 13, three cycle data are displayed in the image P4 in ascending date and time order. In this example, the information processing device X displays, in the image P4, the device operation start information indicating that the power of the injection molding device is turned on, in association with the cycle date acquired at the oldest date and time among the cycle dates acquired within each operation period. A mark M2 shown in FIG. 13 is an example of such device operation start information. Therefore, in this example, among the three cycle data displayed in the image P4, the two cycle data, that is, the uppermost cycle data and the middle cycle data, are cycle data acquired by the information processing device X within the common operation period. In FIG. 13, these two cycle data are surrounded by a frame W3. Therefore, when the information processing device X receives the operation period as the target operating period, the information processing device X can acquire these two pieces of cycle data as the target data from among the cycle data stored in the storage section 32. After acquiring the target data, the information processing device X groups the acquired target data as the data group, and associates the target memo data with the grouped data group.

One of the plurality of extraction condition candidates may be, for example, a fourth extraction condition candidate. The fourth extraction condition candidate is also a condition for extracting the target type injection molding related data acquired by the information processing device X as the target data. Specifically, the fourth extraction condition candidate is the target type injection molding related data extracted according to search keys received from the user. The search keys may be any search keys as long as the search keys are capable of searching for the target type injection molding related data. Hereinafter, as an example, a case will be described in which the search keys are each of the device identification information and a period information indicating the period including the date and time when the target type injection molding related data is acquired by the information processing device 20.

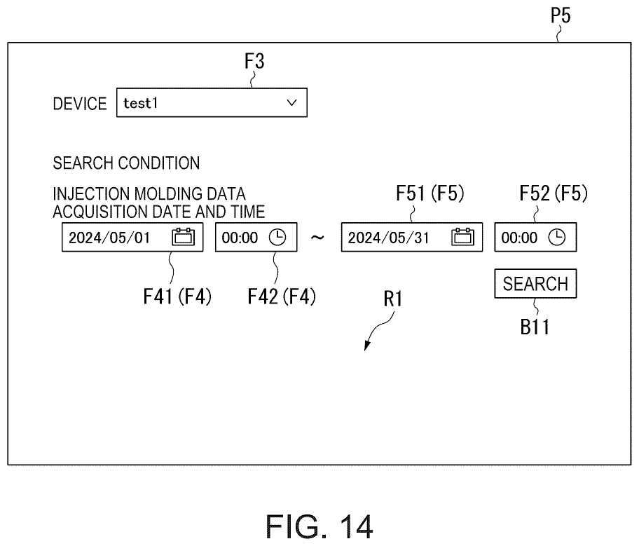

FIG. 14 is a diagram showing an example of a search image P5. In the example shown in FIG. 14, the search image P5 includes an input field F3, an input field F4, an input field F5, a button B11, and a search result display region R1. Note that the search image P5 may include other GUI capable of receiving an operation of searching the target type injection molding related data, instead of a part or all of these GUIs, or in addition to all of these GUIs. After identifying the target type injection molding related data, the information processing device X displays the search image P5 for receiving the search keys for searching the identified target type injection molding related data, for example, in response to the received operation.

The input field F3 is a field in which is input the device identification information for identifying the injection molding device that has output the target type injection molding related data desired by the user. In the example shown in FIG. 14, “test 1” is input in the input field F3 as an example of the device identification information. The device identification information may be input to the input field F3 by selecting the device identification information from a pull-down menu or by directly inputting the device identification information using an input device such as a keyboard.

The input field F4 and the input field F5 are fields in which is input the above described period information. In the example shown in FIG. 14, the input field F4 is a field in which is input start date and time information indicating a date and time at which a period desired by the user starts. In this example, the input field F5 is a field in which is input end date and time information indicating a date and time at which the period ends.

More specifically, the input field F4 is composed of two input fields, an input field F41, and an input field F42. The input field F41 is a field in which is input start date information indicating a date among the date and time information indicated by the start date and time information described above. In the example shown in FIG. 14, in the input field F41, “2024 May 1” indicating May 1, 2024, is input as an example of the start date information. Note that the start date information may be input to the input field F41 by selecting information from a pull-down menu, by selecting a date from an image showing a calendar, or by directly inputting using the input device such as the keyboard. On the other hand, the input field F42 is a field in which is input start time information indicating a time among the date and time information indicated by the start date and time information. In the input field F42, “00:00” indicating 0:00 is input as an example of the start time information. Note that the start time information may be input to the input field F42 by selecting information from a pull-down menu, by specifying a time using an image representing a watch, or by directly inputting information using the input device such as the keyboard.

The input field F5 is composed of two input fields, an input field F51, and an input field F52. The input field F51 is a field in which is input end date information indicating a date among the date and time information indicated by the end date and time information. In the example shown in FIG. 14, in the input field F51, “2024 May 31” indicating May 31, 2024, is input as an example of the end date information. Note that the end date information may be input to the input field F51 by selecting information from a pull-down menu, by selecting a date from an image showing a calendar, or by directly inputting information using the input device such as the keyboard. On the other hand, the input field F52 is a field in which is input end time information indicating a time among the date and time information indicated by the end date and time information. In the input field F52, “00:00” indicating 0:00 is input as an example of the end time information. Note that the end time information may be input to the input field F52 by selecting information from a pull-down menu, by specifying a time using an image representing a watch, or by directly inputting information using the input device such as the keyboard.

The button B11 is a button that receives an operation of executing search of the target type injection molding related data based on the search keys by using each piece of information input to a part or all of the input field F3 to the input field F5 as the search keys. That is, when the information processing device X receives a selection operation at the button B11, it extracts one or more target type injection molding related data corresponding to each information inputted in a part or all of the input field F3 to the input field F5 as the search result. The information processing device X then displays a list of the extracted one or more target type injection molding related data in the search result display region R1 as the data group of the target data group. Note that in the present embodiment, the selection operation is a click, a tap, or the like, but is not limited to these. The search image P5 shown in FIG. 14 is an image before the extraction of the one or more target type injection molding related data is executed. Therefore, nothing is displayed in the search result display region R1 shown in FIG. 14. Note that a method of extracting one or more target type injection molding related data according to each piece of information input to some or all of the input field F3 to the input field F5, that is, a method of searching for the one or more target type injection molding related data may be a known method or a method to be developed in the future. When a selection operation is performed at the button B11 in a case where information is not input to all of the input field F3 to the input field F5, the information processing device X may be configured to display a list of all of one or more target type injection molding related data stored in advance as the data group of the target data in the search result display region R1, or may be configured not to display anything in the search result display region R1.

As described above, the information processing device X can acquire the target type injection molding related data extracted according to the search keys received from the user as the target data. After acquiring the target data, the information processing device X groups the acquired target data as the data group, and associates the target memo data with the grouped data group.

One of the plurality of extraction condition candidates may be, for example, a fourth extraction condition candidate. The fourth extraction condition candidate is also a condition for extracting the target type injection molding related data acquired by the information processing device X as the target data. Specifically, the fourth extraction condition candidate is the target type injection molding related data continuously acquired within a designated target time interval among the target type injection molding related data continuously acquired for the date and time. Here, the target time interval is, for example, 10 minutes, 30 minutes, 1 hour, 2 hours, or the like, but is not limited to these. In this case, after specifying the target type injection molding related data, the information processing device X receives the target time interval, for example, in accordance with the received operation. When there is a plurality of data groups of the target type injection molding related data continuously acquired within the designated target time interval among the target type injection molding related data continuously acquired for the date and time, the information processing device X receives an operation of selecting which data group is a desired data group from the user. By this, the information processing device X can acquire the desired data group among the data groups of the target type injection molding related data continuously acquired within the received target time interval as the data group of the target data from the target type injection molding related data stored in the storage section 32.

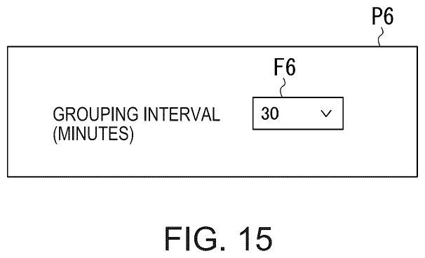

FIG. 15 is a diagram showing an example of an image P6 received by the information processing device X with a time interval desired by a user as a target time interval. The image P6 includes, for example, an input field F6. Note that the image P6 may include other GUI in addition to the input field F6.

The input field F6 is a field for receiving the time interval desired by the user as the target time interval. When the time interval is input to the input field F6, the information processing device X receives the input time interval as the target time interval. In the example shown in FIG. 15, a numerical value of “30” indicating 30 minutes is input to the input field F6, as an example. Note that the time interval may be input in the input field F6 by selecting the time interval from a pull-down menu or by directly inputting the time interval using the entry device such as the keyboard.

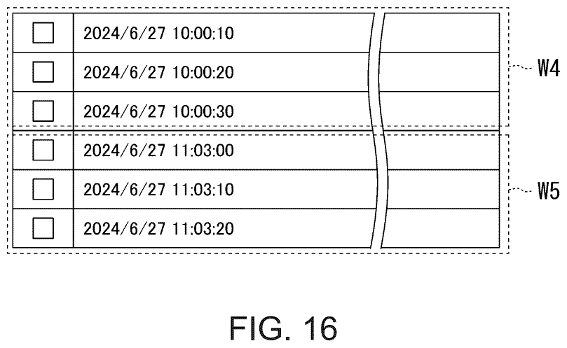

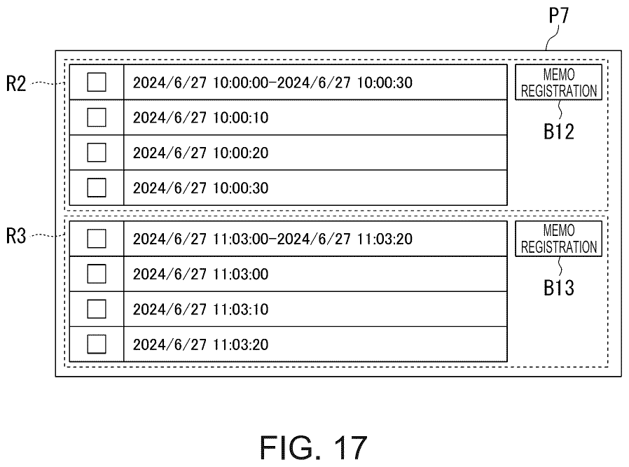

As shown in FIG. 15, when the information processing device X receives the time interval of 30 minutes as the target time interval, the target type injection molding related data is grouped into a plurality of data groups as shown in FIG. 16, for example. FIG. 16 is a diagram showing the target type injection molding related data grouped into two data groups according to the target time interval. In FIG. 16, six pieces of target type injection molding related data are arranged in ascending date and time order. In FIG. 16, only the information indicating the date and time acquired by the information processing device X among the pieces of information included in the six pieces of target type injection molding related data is shown. Therefore, these six pieces of target type injection molding related data may be the cycle data, the injection molding condition data, or the operational status history data. These six pieces of target type injection molding related data are continuously acquired with respect to the date and time. When the target time interval is 30 minutes, the target type injection molding related data continuously acquired within the target time interval among the six target type injection molding related data is grouped into two data groups the data group including three target type injection molding related data surrounded by a frame W4 and the data group including three target type injection molding related data surrounded by a frame W5. The information processing device X receives an operation of selecting which of the two data groups is the desired data group from the user via the image P7 shown in FIG. 17, for example. FIG. 17 is a diagram showing an example of the image P7 that receives an operation of selecting a desired data group from among the plurality of data groups. Note that, in the following description, for convenience of explanation, the group of three target type injection molding related data surrounded by the frame W4 is referred to as a first dataset group, and the group of three target type injection molding related data surrounded by the frame W5 is referred to as a second data group.

In the example shown in FIG. 17, the image P7 includes a first region R2 in which the first data group is displayed, a button B12 displayed in association with the first region R2, a second region R3 in which the second data group is displayed, and a button B13 displayed in association with the second region R3. Note that the image P7 may include other GUI in addition to these.

In the first region R2, the three target type injection molding related data included in the first data group are displayed in ascending date and time order. In the first region R2, corresponding check boxes are displayed for the three target type injection molding related data. These check boxes are images for receiving an operation of selecting the corresponding target type injection molding related data from the user. In the first region R2, a check box for receiving an operation of selecting all of the target type injection molding related data corresponding to each of the check boxes is displayed.

The button B12 is a button for receiving an operation of confirming that all of the target type injection molding related data selected by the check boxes in the first region R2 are selected as the target data.

In the second region R3, the three target type injection molding related data included in the second data group are displayed in ascending date and time order. In the second region R3, corresponding check boxes are displayed for the three target type injection molding related data. These check boxes are images for receiving an operation of selecting the corresponding target type injection molding related data from the user. In the second region R3, a check box for receiving an operation of selecting all of the target type injection molding related data corresponding to each of the check boxes is displayed.

The button B13 is a button for receiving an operation of confirming that all of the target type injection molding related data selected by the check boxes in the second region R3 are selected as the target data.

By receiving the operation from the user via such the image P7, the information processing device X can specify whether the data group desired by the user is the first data group or the second data group, and specifies the target type injection molding related data included in the specified data group as the target data. The information processing device X can also specify only the target type injection molding related data desired by the user among the target type injection molding related data included in the first data group as the target data via the image P7. The information processing device X can also specify only the target type injection molding related data desired by the user among the target type injection molding related data included in the second data group as the target data via the image P7.

The information processing device X can specify the target data by using the specific examples of the extraction condition candidates as described above. The extraction condition candidates described above may be combined in any manner. The extraction condition candidates may include other conditions.

### Process of Analyzing Memo Data Associated with Injection Molding Related Data by Information Processing Device X

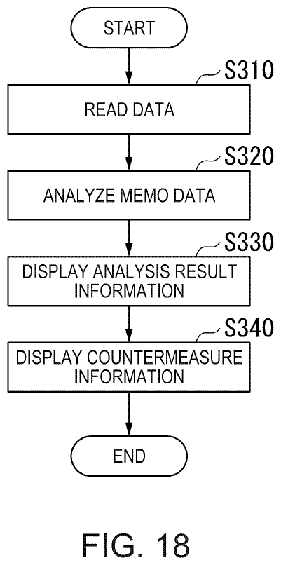

Hereinafter, a process in which the information processing device X analyzes the memo data associated with the injection molding related data will be described with reference to FIG. 18. FIG. 18 is a diagram showing an example of a flow of the process in which the information processing device X analyzes the memo data associated with the injection molding related data. Hereinafter, as an example, a case will be described in which, at a timing before the process of step S310 shown in FIG. 18 is performed, the memo data has already been associated with a part or all of the injection molding related data stored in the storage section 32. Hereinafter, as an example, a case will be described in which, at the timing, the information processing device X has already received an operation of selecting the injection molding related data to be a target to be used for analysis. A method of receiving the operation by the information processing device X may be a known method or a method to be developed in the future. Hereinafter, for convenience of description, the injection molding related data to be used for analysis will be referred to as analysis target injection molding related data. Hereinafter, as an example, a case will be described in which the memo data associated with each piece of the analysis target injection molding related data includes text data indicating the temperature of a metal mold.

After receiving the operation of selecting the analysis target injection molding related data, the control section 34 reads the analysis target injection molding related data from the storage section 32 (step S310). In FIG. 18, the process of step S310 is indicated by “READ DATA”.

Next, the control section 34 extracts the memo data associated with each of the analysis target injection molding related data read in step S310, and analyzes the extracted memo data (step S320). The control section 34 analyzes the memo data by using natural language analysis, statistical analysis, or the like. Specifically, for example, the control section 34 generates a graph indicating a temporal change in the temperature of the metal mold based on the text data included in each piece of the extracted memo data. For example, the control section 34 determines the presence or absence of the correlation between the abnormality occurring in the cycle and the temperature of the metal mold based on the analysis target injection molding related data and the memo data, and generates correlation presence or absence information indicating the determination result. The control section 34 estimates the cause of the abnormality that has occurred in the cycle based on the generated graph and the correlation presence or absence information, and generates estimated abnormality cause information indicating the result of the estimation. The control section 34 calculates an appropriate temperature of the metal mold and generates appropriate temperature information indicating the calculated temperature. Then, the control section 34 generates information including each of the generated graph, the correlation presence or absence information, the estimated abnormality cause information, and the appropriate temperature information as analysis result information indicating the analysis result. The analysis method, the analysis process, and the like of the memo data by the control section 34 are merely examples, and it is not limited to these. In FIG. 18, the process of step S320 is indicated by “ANALYZE MEMO DATA”. The graph generated by the control section 34 may be a part or all of a line graph, a histogram, a pie chart, a radar chart, and the like. This is because it is considered that it can be used to identify the cause of the abnormality that occurs in the cycle. By such analysis, for example, when the abnormality occurs in a cycle, the user can easily specify the cause of the abnormality and can easily specify the quantity of lots affected by the abnormality that has occurred. The user can grasp, for example, the stock that can be shipped to the customer in this case. Note that the memo data may include text data indicating whether or not the injection molding in the cycle is successful, text data indicating the loss that has occurred, and the like, instead of the text data such as the text data indicating the temperature of the metal mold, or in addition to the text data. By this, the user can easily specify the injection molding condition under which the injection molding has failed, the injection molding condition under which the loss increases, and the like. Such memo data can also be used as experimental data in the development of similar products. The memo data may include data indicating information that cannot be acquired from the injection molding device. The data may be, for example, customer specific data such as company name, department name, shipping address, experimental materials, customer specific materials, or the like of the customer who placed the order for the injection molded product, data detected by sensors, data indicating conditions under which the injection molding device is to be operated, or the like, but is not limited to these. Examples of the value indicated by the text data included in the memo data include, a chiller cooling temperature, an ambient temperature, a melt flow value of an injection molded product, a tensile strength of the product, and a compressive strength of the product, in addition to the temperature of the metal mold, but is not limited to these. An example of the speech data included in the memo data is speech data indicating an actual value of injection molding, but the speech data is not limited to this.

Next, the control section 34 displays the analysis result information indicating the results of the analyze performed in step S320 (step S330). In FIG. 18, the process of step S330 is indicated by “DISPLAY ANALYSIS RESULT INFORMATION”.

Next, the control section 34 displays countermeasure information indicating a countermeasure to be taken by the user based on the result of the analysis performed in step S320, the AI, and the like (step S340). A method of generating such countermeasure information may be a known method or a method to be developed in the future. In FIG. 18, the process of step S340 is indicated by “DISPLAY COUNTERMEASURE INFORMATION”. After the process of step S340 is performed, the control section 34 ends the process of the flowchart shown in FIG. 18.

As described above, the information processing device X analyzes the memo data associated with the injection molding related data stored in the storage section 32 in accordance with the received operation, and displays the analysis result information indicating the result of the analysis. By this, the information processing device X can easily specify the cause of the abnormality that has occurred in the cycle of the injection molding by the injection molding device.

### Modification Example of Embodiment

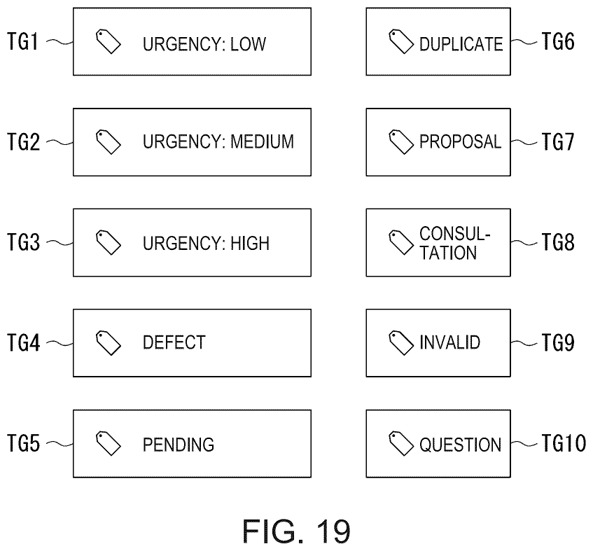

Hereinafter, a modification example of the embodiment will be described. The information processing device X may be configured to, after specifying the target data, display at least a part of the specified target data in association with the designated second additional information among the plurality of pieces of second additional information determined in advance. Here, the second additional information may be any information as long as it is additional information that can be associated with the target data, and is, for example, an image indicating any of a tag, a label, a title, and a mark, but is not limited to these. FIG. 19 is a diagram showing the plurality of pieces of the second additional information as images indicating tags. In the example shown in FIG. 19, the second additional information is an image indicating each of ten types of the tags different from each other. Specifically, in this example, the plurality of pieces of second additional information determined in advance are a tag TG1 to a tag TG10. The tag TG1 is an image indicating that the urgency is low. The tag TG2 is an image indicating that the urgency is medium. The tag TG3 is an image indicating that the urgency is high. The tag TG4 is an image indicating that a defect has occurred. The tag TG5 is an image indicating that the job is pending. The tag TG6 is an image indicating that the tag is duplicated. The tag TG7 is an image indicating that there is a proposal. The tag TG8 is an image indicating that there is a consultation. The tag TG9 is an image indicating that it is invalid. The tag TG10 is an image indicating that there is a question.

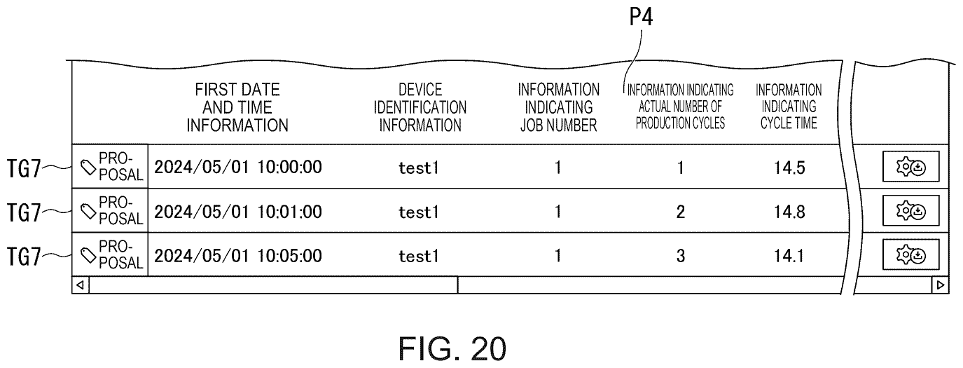

The information processing device X extracts the injection molding related data associated with the designated second additional information from the data stored in the storage section 32 according to the received operation, and displays the extracted injection molding related data. FIG. 20 is a diagram showing an example of a state in which the list of cycle data associated with a tag TG7 is displayed. In the example shown in FIG. 20, the information processing device X displays the list of cycle date associated with the tag TG7 as an example of the injection molding related data associated with the tag TG7. By this, the user can search for the injection molding related data based on the second additional information, and can easily specify the desired injection molding related data. This is useful because it leads to easy identification of the cause of the abnormality that has occurred in the cycle, easy understanding of the matters necessary for execution of the cycle, and the like.

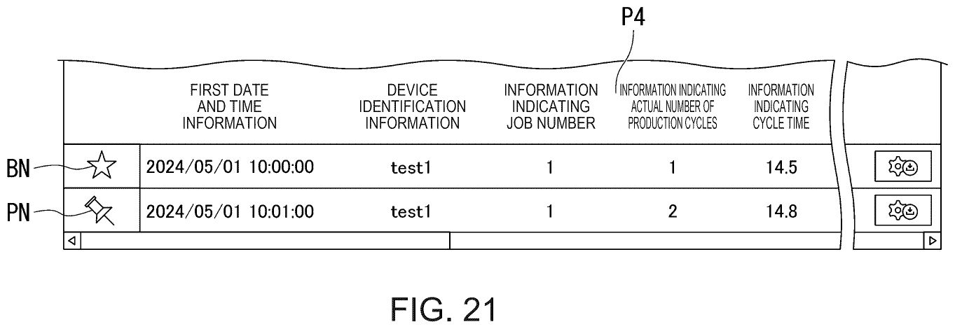

FIG. 21 is a diagram showing an example of a state in which the list of cycle data associated with each of two types of second additional information is displayed. In the example shown in FIG. 21, an image indicating a bookmark, which is an example of the second additional information, is associated with the cycle data in the uppermost row. In this example, an image indicating pinning, which is an example of the second additional information, is associated with the cycle data in the lowermost row. In this way, the information processing device X can extract the injection molding related data associated with each of the two or more types of designated second additional information from the data stored in the storage section 32 according to the received operation.

The molding management system 1 described above may include the terminal device 40. The molding management system 1 described above may be configured to include an injection molding device such as the injection molding device 11.

The information processing device 20 described above may be configured to associate a plurality of injection molding condition data with one piece of cycle data.

The image data described above may be data representing a still image or data representing a moving image.

The memo indicated by the memo data described above is, for example, a material name memo, a customer case memo, a trial memo, a worker takeover item memo, a quality defect confirmation request memo, a defective operation memo, or the like, but is not limited to these.

The second additional information described above may be, for example, an image indicating other information such as an image indicating caution or an image indicating stability.

One of the extraction condition candidates described above may be target type injection molding related data arbitrarily designated by the user.

The contents described above may be combined in any manner.

### Appendix 1

[1] A molding management system for managing production of a product in a production process including an injection molding process of the product by an injection molding device, the molding management system includes an information processing device communicatively connected to a terminal device, wherein the information processing device includes a storage section configured to store data relating to injection molding and a control section, the data is associated with memo data indicating additional information, and the control section is configured to analyze the memo data associated with the data stored in the storage section in response to a received operation and to cause a display section to display analysis result information indicating a result of the analysis.
[2] The molding management system according to [1], wherein the control section is configured to cause the display section to display the memo data associated with the data together with the data in accordance with the received operation.
[3] The molding management system according to [1] or [2], wherein the data is cycle data obtained in accordance with execution by the injection molding device of a cycle in which the injection molding device performs injection molding.
[4] The molding management system according to any one of [1] to [3], wherein the data is injection molding condition data indicating an injection molding condition set in the injection molding device.
[5] The molding management system according to any one of [1] to [4], wherein the data is operational status history data indicating a history of an operational status of the injection molding device.
[6] The molding management system according to any one of [1] to [5], wherein the memo data includes at least one of text data, image data, speech data, and read data read from encoded data indicating encoded information and the control section is configured to cause the display section to display an operation reception image for receiving an operation of associating the memo data with the data.
[7] The molding management system according to [6], wherein the memo data includes at least the text data and the operation reception image includes a text reception image for receiving the text data.
[8] The molding management system according to [6] or [7], wherein the memo data includes at least the image data and the operation reception image includes an image reception image for receiving the image data.
[9] The molding management system according to any one of [6] to [8], wherein the memo data includes at least the speech data and
the operation reception image includes a speech reception image for receiving the speech data.
[10] The molding management system according to [9], wherein the speech reception image includes a speech recording start image for receiving a speech recording start operation that starts recording of speech and a speech recording end image for receiving a speech recording end operation that ends recording of speech and the control section receives, as the speech data, data indicating speech that was recorded within a period from when the speech recording start operation is received to when the speech recording end operation is received.
[11] The molding management system according to any one of [6] to [10], wherein the memo data includes at least the read data and the operation reception image includes a read operation reception image for receiving an operation to cause an encoded data reading device, which reads the read data from the encoded data, to start reading the read data.
[12] The molding management system according to any one of [1] to [11], wherein the control section is configured to associate the memo data with all of the plurality of pieces of data designated in accordance with the received operation.
[13] The molding management system according to any one of [1] to [12], further including the terminal device.
[14] The molding management system according to any one of [1] to [13], further including the injection molding device.

### Appendix 2

[1] A molding management system for managing production of a product in a production process including an injection molding process of the product by an injection molding device, the molding management system includes an information processing device communicatively connected to a terminal device, wherein the information processing device includes a storage section configured to store data relating to injection molding and a control section, the control section is configured to set a plurality of pieces of data satisfying a condition received in advance as a data group in accordance with a received operation, and causes a display section to display an operation reception image for receiving an operation of associating memo data indicating additional information with all of the plurality of pieces of data included in the data group.
[2] The molding management system according to [1], wherein the control section is configured to cause the display section to display a data group display image for receiving an operation of causing the display section to display the data group associated with the memo data, in accordance with the received operation.
[3] The molding management system according to [1] or [2], wherein the data is cycle data obtained in accordance with execution by the injection molding device of a cycle in which the injection molding device performs injection molding.
[4] The molding management system according to any one of [1] to [3], wherein the condition is the data acquired within a designated period among the data not stored in the storage section.
[5] The molding management system according to any one of [1] to [4], wherein the condition is the data designated data among the data stored in the storage section.
[6] The molding management system according to any one of [1] to [5], wherein the condition is the data associated with injection molding condition data indicating the common injection molding condition among the data stored in the storage section.
[7] The molding management system according to any one of [1] to [6], wherein The condition is the data acquired within a period from when the power supply of the injection molding device is turned on to when the power supply of the injection molding device is turned off among the data stored in the storage section.
[8] The molding management system according to any one of [1] to [7], wherein the condition is the data continuously acquired within a designated time interval among the data stored in the storage section.
[9] The molding management system according to any one of [1] to [8], wherein the memo data includes at least one of text data, image data, speech data, and read data read from encoded data indicating encoded information.
[10] The molding management system according to any one of [1] to [9], wherein the information processing device is configured to cause the display section to display at least a part of the plurality of pieces of data included in the data group in association with designated second additional information among a plurality of pieces of predetermined second additional information in accordance with the received operation.
[11] The molding management system according to [10], wherein the second additional information is an image indicating any one of a tag, a label, a title, and a mark.
[12] The molding management system according to [10] or [2], wherein the control section is configured to extract the data associated with the designated second additional information from the data stored in the storage section in accordance with the received operation, and cause the display section to display the extracted data.
[13] The molding management system according to any one of [1] to [12], further includes the terminal device.
[14] The molding management system according to any one of [1] to [13], further includes the injection molding device.

Although the embodiments of the present disclosure have been described in detail with reference to the drawings, specific configurations are not limited to the embodiments, and changes, substitutions, deletions, and the like may be made without departing from the gist of the present disclosure.

A program for implementing the functions of any of the components in the above described device may be recorded on a computer-readable recording medium, and the program may be read into a computer system for execution. Here, the device is, for example, the injection molding device 11, the information processing device 20, the server 30, the terminal device 40, or the like. Note that the “computer system” referred to here includes an Operating System (OS) and hardware such as peripheral devices. The “computer-readable recording medium” refers to a portable medium such as a flexible disk, a magneto-optical disk, a ROM, a Compact Disk (CD)-ROM, or a storage device such as a hard disk built into the computer system. Furthermore, the “computer-readable recording medium” includes a medium that holds a program for a certain period of time, such as a volatile memory inside a computer system serving as a server or a client when the program is transmitted via a network such as the Internet or a communication line such as a telephone line.

The program may be transmitted from a computer system in which the program is stored in a storage device or the like to another computer system via a transmission medium or by a transmission wave in the transmission medium. Here, the “transmission medium” for transmitting the program refers to a medium having a function of transmitting information, such as a network, such as the Internet, or a communication line, such as a telephone line.

The program may be a program for realizing a part of the above described functions. Furthermore, the program may be a so-called differential file or differential program that can realize the above described functions in combination with a program already recorded in the computer system.

What is claimed is:

1. A molding management system for managing production of a product in a production process including an injection molding process of the product by an injection molding device, the molding management system comprising:
an information processing device communicatively connected to a terminal device, wherein
the information processing device includes
a storage section configured to store data relating to injection molding and
a control section,
the data is associated with memo data indicating additional information, and
the control section is configured to analyze the memo data associated with the data stored in the storage section in response to a received operation and to cause a display section to display analysis result information indicating a result of the analysis.

2. The molding management system according to claim 1, wherein
the control section is configured to cause the display section to display the memo data associated with the data together with the data in accordance with the received operation.

3. The molding management system according to claim 1, wherein
the data is cycle data obtained in accordance with execution by the injection molding device of a cycle in which the injection molding device performs injection molding.

4. The molding management system according to claim 1, wherein
the data is injection molding condition data indicating an injection molding condition set in the injection molding device.

5. The molding management system according to claim 1, wherein
the data is operational status history data indicating a history of an operational status of the injection molding device.

6. The molding management system according to claim 1, wherein
the memo data includes at least one of text data, image data, speech data, and read data read from encoded data indicating encoded information and
the control section is configured to cause the display section to display an operation reception image for receiving an operation of associating the memo data with the data.

7. The molding management system according to claim 6, wherein
the memo data includes at least the text data and
the operation reception image includes a text reception image for receiving the text data.

8. The molding management system according to claim 6, wherein
the memo data includes at least the image data and
the operation reception image includes an image reception image for receiving the image data.

9. The molding management system according to claim 6, wherein
the memo data includes at least the speech data and
the operation reception image includes a speech reception image for receiving the speech data.

10. The molding management system according to claim 9, wherein
the speech reception image includes a speech recording start image for receiving a speech recording start operation that starts recording of speech and a speech recording end image for receiving a speech recording end operation that ends recording of speech and
the control section receives, as the speech data, data indicating speech that was recorded within a period from when the speech recording start operation is received to when the speech recording end operation is received.

11. The molding management system according to claim 6, wherein
the memo data includes at least the read data and
the operation reception image includes a read operation reception image for receiving an operation to cause an encoded data reading device, which reads the read data from the encoded data, to start reading the read data.

12. The molding management system according to claim 1, wherein
the control section is configured to associate the memo data with all of the plurality of pieces of data designated in accordance with the received operation.

13. The molding management system according to claim 1, further comprising:
the terminal device.

14. The molding management system according to claim 1, further comprising:
the injection molding device.
